(19) United States
(12) Patent Application Publication
(10) Pub. No.: US 2017/0245675 A1
(43) Pub. Date: Aug. 31, 2017

(54) Method for Dispensing Baby Formula at a Refrigerator Appliance

(71) Applicant: General Electric Company, Schenectady, NY (US)

(72) Inventors: Brent Alden Junge, Evansville, IN (US); Joel Erik Hitzelberger, Louisville, KY (US)

(21) Appl. No.: 15/055,709

(22) Filed: Feb. 29, 2016

(51) Int. Cl. A47J 31/40; F25D 23/04; F25D 23/12; B65D 85/804

(52) U.S. Cl. CPC A47J 31/401; B65D 85/8043; F25D 23/04; F25D 23/126; A47J 31/407

(57) ABSTRACT

The present subject matter provides a method for dispensing baby formula at a refrigerator appliance. The method includes loading a baby formula module with baby formula, mounting the baby formula module within a dispenser recess of the refrigerator appliance, detecting the baby formula module with a sensor of the refrigerator appliance, measuring a temperature of water within a hot water tank of the refrigerator appliance, flowing water from the hot water tank to the baby formula module when the temperature of water within the hot water tank is no greater than a temperature limit, and directing a mixture of baby formula and water out of the baby formula module into the dispenser recess. A related refrigerator appliance is also provided.

### FIELD OF THE INVENTION

The present subject matter relates generally to refrigerator appliances, and more particularly for methods for single serve dispenser use in refrigerator appliances.

### BACKGROUND OF THE INVENTION

Refrigerator appliances can include a dispenser for directing ice from the refrigerator's ice maker and/or liquid water to the dispenser. A user can activate the dispenser to direct a flow of ice or liquid water into a cup or other container positioned within the dispenser. Liquid water directed to the dispenser is generally chilled or at an ambient temperature.

Certain refrigerator appliances also include features for dispensing heated liquid water. The heated liquid water can be used to make hot beverages, such as coffee or tea. However, hot beverages brew or steep at various temperatures. For example, coffee is preferably brewed with water at a high temperature between one hundred and ninety-five degrees Fahrenheit and two hundred and five degrees Fahrenheit. Refrigerators equipped to dispense heated liquid water can operate to hold a volume of water at such high temperatures in order to assist with quickly dispensing heated water for brewing coffee. However, high temperature water is not desirable for all beverages, such as baby formula.

Accordingly, a refrigerator appliance with features for dispensing heated water and for mixing baby formula would be useful. In particular, a method for dispensing heated water from a refrigerator appliance at a temperature suitable for mixing baby formula would be useful.

### BRIEF DESCRIPTION OF THE INVENTION

The present subject matter provides a method for dispensing baby formula at a refrigerator appliance. The method includes loading a baby formula module with baby formula, mounting the baby formula module within a dispenser recess of the refrigerator appliance, detecting the baby formula module with a sensor of the refrigerator appliance, measuring a temperature of water within a hot water tank of the refrigerator appliance, flowing water from the hot water tank to the baby formula module when the temperature of water within the hot water tank is no greater than a temperature limit, and directing a mixture of baby formula and water out of the baby formula module into the dispenser recess. A related refrigerator appliance is also provided. Additional aspects and advantages of the invention will be set forth in part in the following description, or may be apparent from the description, or may be learned through practice of the invention.

In a first exemplary embodiment, a method for dispensing baby formula at a refrigerator appliance is provided. The method includes loading a baby formula module with baby formula, mounting the baby formula module within a dispenser recess of the refrigerator appliance, detecting the baby formula module with a sensor of the refrigerator appliance, measuring a temperature of water within a hot water tank of the refrigerator appliance, flowing water from the hot water tank to the baby formula module when the temperature of water within the hot water tank is no greater than a temperature limit, and directing a mixture of baby formula and water out of the baby formula module into the dispenser recess.

In a second exemplary embodiment, a refrigerator appliance is provided. The refrigerator appliance includes a cabinet that defines a chilled chamber. A door is mounted to the cabinet. A dispenser is mounted to the door. The dispenser defines a recess. A water heater is disposed within the cabinet and has a conduit that extends to the recess. A baby formula module is mounted to the dispenser at the recess of the dispenser such that heated water from the water heater is receivable within the baby formula module. The baby formula module includes a pod disposed within a body of the baby formula module. The pod is filled with baby formula.

In a third exemplary embodiment, a method for dispensing a liquid mixture at a refrigerator appliance is provided. The method include loading a mixture module with a fluid additive, mounting the mixture module within a dispenser recess of the refrigerator appliance, detecting the mixture module with a sensor of the refrigerator appliance, measuring a temperature of water within a hot water tank of the refrigerator appliance, flowing water from the hot water tank to the mixture module when the temperature of water within the hot water tank is no greater than a temperature limit, and directing a mixture of fluid additive and water out of the mixture module into the dispenser recess.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 provides a front, elevation view of a dispensing assembly of the exemplary refrigerator appliance of FIG. 1.

FIG. 3 provides a schematic view of various components of the exemplary refrigerator appliance of FIG. 1.

FIG. 4 provides a perspective view of a pod and a baby formula module of the exemplary refrigerator appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

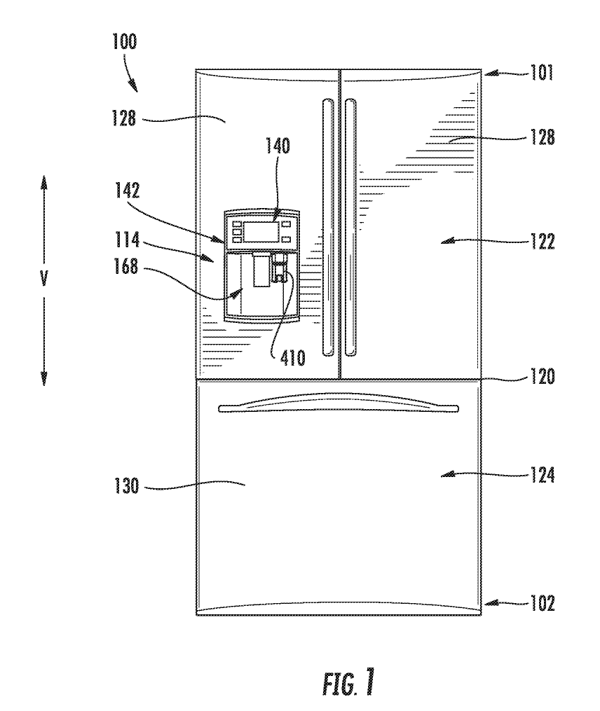

FIG. 1 provides a front, elevation view of a refrigerator appliance 100 according to an exemplary embodiment of the present subject matter. Refrigerator appliance 100 includes a cabinet or housing 120. Housing 120 extends between an upper portion 101 and a lower portion 102 along a vertical direction V. Housing 120 defines chilled chambers, e.g., a fresh food compartment 122 positioned adjacent upper portion 101 of housing 120 and a freezer compartment 124 arranged at lower portion 102 of housing 120. Housing 120 also defines a mechanical compartment (not shown) for receipt of a sealed cooling system for cooling fresh food compartment 122 and freezer compartment 124.

Refrigerator appliance 100 is generally referred to as a bottom-mount refrigerator appliance. However, it should be understood that refrigerator appliance 100 is provided by way of example only. Thus, the present subject matter is not limited to refrigerator appliance 100 and may be utilized in any suitable refrigerator appliance. For example, one of skill in the art will understand that the present subject matter may be used with side-by-side style refrigerator appliances or top-mount refrigerator appliances as well.

Refrigerator doors 128 are rotatably hinged to housing 120 proximate fresh food compartment 122 in order to permit selective access to fresh food compartment 122. A freezer door 130 is arranged below refrigerator doors 128 for accessing freezer compartment 124. Freezer door 130 is mounted to a freezer drawer (not shown) slidably coupled within freezer compartment 124.

Refrigerator appliance 100 may also include a dispensing assembly 110 for dispensing various fluids, such as liquid water and/or ice, to a dispenser recess 168 defined on one of refrigerator doors 128. Dispensing assembly 110 includes a dispenser 114 positioned on an exterior portion of refrigerator appliance 100. Dispenser 114 includes several outlets for accessing ice, chilled liquid water, and heated liquid water. To access ice, chilled liquid water, and heated liquid water, water-dispensing assembly 110 may for example include a paddle 134 mounted below a chilled water outlet 132, a heated water outlet 150 and an ice outlet 136. As an example, a user can urge a vessel, such as a cup, against paddle 134 to initiate a flow of chilled liquid water, heated liquid water and/or ice into the vessel within dispenser recess 168. In particular, a control panel or user interface panel 140 may be provided for controlling the mode of operation of dispenser 114, e.g., for selecting chilled liquid water, heated liquid water, crushed ice and/or whole ice. User interface panel 140 can include a chilled water dispensing button (not labeled), an ice-dispensing button (not labeled) and a heated water dispensing button (not labeled) for selecting between chilled liquid water, ice and heated liquid water, respectively.

Outlets 132, 136, and 150 and paddle 134 may be an external part of dispenser 114, and are positioned at or adjacent dispenser recess 168, e.g., a concave portion defined in an outside surface of refrigerator door 128. Dispenser 114 is positioned at a predetermined elevation convenient for a user to access ice or liquid water, e.g., enabling the user to access ice without the need to bend-over and without the need to access freezer compartment 124. In the exemplary embodiment, dispenser 114 is positioned at a level that approximates the chest level of a user.

Operation of the refrigerator appliance 100 can be regulated by a controller 170 that is operatively coupled to user interface panel 138 and/or various sensors as discussed below. User interface panel 138 provides selections for user manipulation of the operation of refrigerator appliance 100 such as e.g., selections between whole or crushed ice, chilled water, and/or other various options. In response to user manipulation of the user interface panel 138 or sensor signals, controller 170 may operate various components of the refrigerator appliance 100. Controller 170 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 170 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 170 may be positioned in a variety of locations throughout refrigerator appliance 100. In the illustrated embodiment, controller 170 is located within the user interface panel 138. In other embodiments, the controller 170 may be positioned at any suitable location within refrigerator appliance 100, such as for example within a fresh food chamber, a freezer door, etc. Input/output (“I/O”) signals may be routed between controller 170 and various operational components of refrigerator appliance 100. For example, user interface panel 138 may be in communication with controller 170 via one or more signal lines or shared communication busses.

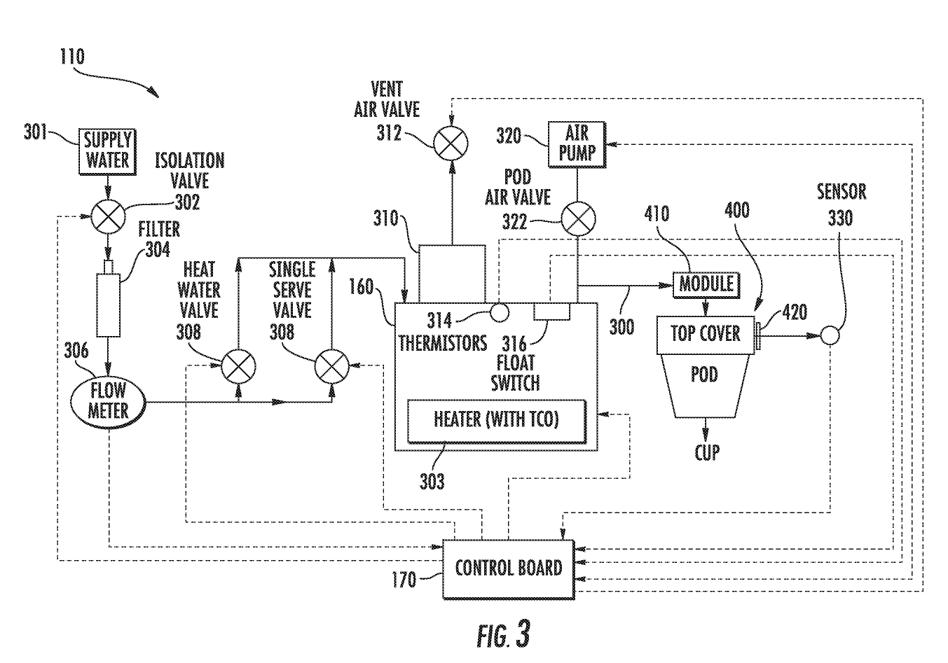

Refrigerator appliance 100 also includes features for generating heated liquid water and directing such heated liquid water to dispenser 114. Thus, refrigerator appliance 100 need not be connected to a residential hot water heating system in order to supply heated liquid water to dispenser 114. Such features of refrigerator appliance 100 are discussed in greater detail below in the context of FIG. 3.

FIG. 3 is a schematic illustration of one embodiment of various components of dispensing assembly 110. The various components of dispensing assembly 110 illustrated in FIG. 3 may be provided to generate heated water and guide such heated water to dispenser 114. Such components may variously be disposed in, for example, the dispenser 114, a door 128, 130, or another suitable location in the refrigerator appliance 100.

As may be seen in FIG. 3, dispensing assembly 110 includes a water heater or water heating assembly 160, e.g., mounted within refrigerator door 128, with a tank for heating water therein. Heated water from water heating assembly 160 may exit water heating assembly 160 and flow towards dispenser 114 via an outlet conduit 300. Thus, outlet conduit 300 may be a conduit or piping that extends from water heating assembly 160 to dispenser 114 in order to direct heated water from water heating assembly 160 to dispenser 114 or components of refrigerator appliance 100 within dispenser 114, as discussed in greater detail below.

As shown in FIG. 3, water may initially be supplied from a liquid source 301 (e.g., a well or municipal water supply) through valve 302, such as an isolation valve, to a filter 304. The water may be filtered in the filter 304, and then flowed through a flow meter 306. One or more valves 308 may then control flow of the water to a tank, such as water heating assembly 160, with a heating element 303. From the tank, the water may flow through outlet conduit 300 to dispenser 114.

Water within water heating assembly 160 may be heated with heating element 303 to a set temperature and used to brew hot beverages. Hot beverages, such as tea or coffee, may be brewed in a brewing module (not shown) other than a baby formula mixing module 410 with the heated water from water heating assembly 160. As example, in the brewing module, coffee is preferably brewed with water between one hundred and eighty degrees Fahrenheit and one hundred and ninety degrees Fahrenheit. To provide heated water to the brewing module quickly, the set temperature of water heating assembly 160 is generally selected to a default or normal value, e.g., between one hundred and eighty degrees Fahrenheit and one hundred and ninety degrees Fahrenheit. Thus, the water heating assembly 160 can normally maintain water at between one hundred and eighty degrees Fahrenheit and one hundred and ninety degrees Fahrenheit, in certain exemplary embodiments.

An expansion chamber 310 may be coupled to the tank to, for example, allow gas generated due to liquid heating in the tank to expand into the expansion chamber 310. A vent valve 312 may allow such gas to escape from the expansion chamber 310. The tank may additionally include, for example, a thermistor 314 and a float switch 316, which may govern the level and supply of water. Further, a gas pump 320 may be provided. The gas pump 320 may supply gas from a suitable gas source, such as the environment when air is utilized, to the dispensing assembly. A gas valve 322 may allow such gas to be provided to the outlet conduit 300. Gas may be provided to outlet conduit 300 via gas pump 320 and gas valve 322. Thus, gas pump 320 and gas valve 322 may be connected to the outlet conduit 300, as shown.

As illustrated, controller 170 may be in communication with the various components of dispensing assembly 110 and may control operation of the various components. For example, the various valves, switches, etc. may be actuatable based on commands from the controller 170. As discussed, interface panel 140 may additionally be in communication with the controller 170. Thus, the various operations may occur based on user input or automatically through controller 170 instruction.

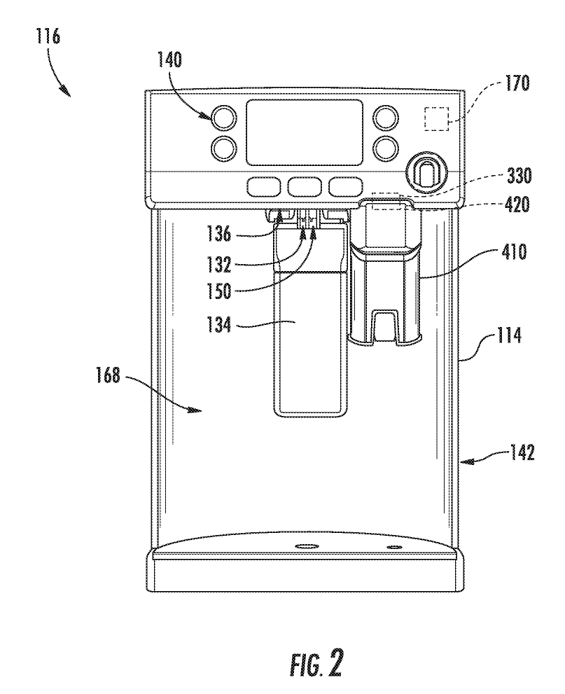

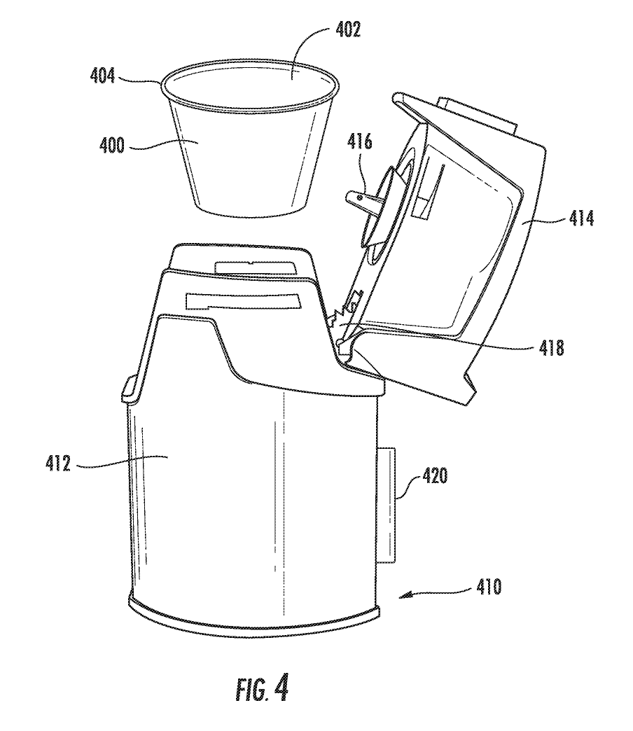

As shown in FIGS. 2 and 3, dispensing assembly 110 includes a baby formula mixing module 410. Baby formula mixing module 410 is mountable within dispenser recess 168 such that baby formula mixing module 410 is in fluid communication with outlet conduit 300 when mounted within dispenser recess 168. Thus, heated water from water heating assembly 160 may flow into baby formula mixing module 410 via outlet conduit 300. Baby formula mixing module 410 is discussed in greater detail below in the context of FIG. 4.

FIG. 4 provides a perspective view of a pod 400 and baby formula mixing module 410 of dispensing assembly 110. Pod 400 is generally a container which contains or is Tillable with a predetermined amount of baby formula, e.g., liquid or powder baby formula, to be mixed with a suitable liquid, such as water, etc. Pod 400 may be a single-use pod or a reusable pod. A top cover 402 of pod 400 may enclose an opening of pod 400. Top cover 402 may be puncturable (e.g., with an injector 416 of baby formula mixing module 410) and/or removable to access the baby formula therein. In particular, the top cover 402 may be formed from a suitable foil material, such as aluminum foil, e.g., when pod 400 is a single-use pod. Pod 400 may additionally include a lip 404, which may facilitate placing the pod 400 in baby formula mixing module 410.

Pod 400 is receivable within baby formula mixing module 410. Thus, pod 400 may be disposed within baby formula mixing module 410, and water from outlet conduit 300 may then be introduced into pod 400 with injector 416 of baby formula mixing module 410. The water may mix with baby formula within pod 400 and/or baby formula mixing module 410, and the mixture of water and baby formula may then flow from baby formula mixing module 410 into, for example, a container or bottle (not shown) typically placed within dispenser recess 168 below baby formula mixing module 410. Baby formula mixing module 410 may include a body 412 and a lid 414. Lid 414 is pivotally attached to body 412 with a hinge 418 that permits lid 414 to pivot open and closed. Thus, lid 414 may permit selective access to an interior of body 412 in which pod 400 may be disposed. Turning back to FIG. 3, outlet conduit 300 may direct gas and/or water into pod 400 and/or baby formula mixing module 410.

As shown in FIG. 3, dispensing assembly 110 also includes a sensor 330, e.g., positioned proximate dispenser 114. Sensor 330 detects and/or is triggered when an actuator 420 on baby formula mixing module 410 is positioned proximate or on sensor 330. Sensor 330 may be any suitable sensor for detecting actuator 420, and actuator 420 may be any suitable actuator for triggering sensor 330. As an example, sensor 330 may be a plunger switch and/or other suitable mechanical switch that engages actuator 420 (e.g., a surface feature on body 412 or lid 414 of baby formula mixing module 410). As another example, sensor 330 may be a Hall effect sensor or magnetic reed switch that is triggered by a magnetic field from actuator 420 (e.g., a magnet on body 412 or lid 414 of baby formula mixing module 410). As yet another example, sensor 330 may be a radio frequency identification (RFID) reader that reads actuator 420 (e.g., an RFID tag on body 412 or lid 414 of baby formula mixing module 410). Sensor 330 may be utilized to detect or determine when baby formula mixing module 410 is mounted within dispenser recess 168. Sensor 330 may also be utilized to detect or determine when another module, such as a coffee brewing module, other than baby formula mixing module 410 is mounted within dispenser recess 168.

Operation of dispensing assembly 110 and baby formula mixing module 410 to dispense a mixture of baby formula and water is described in greater detail below. Baby formula is preferably mixed with heated water at or below a temperature limit. For example, the temperature limit may be no more than one hundred degrees Fahrenheit, no greater than ninety-five degrees Fahrenheit, etc. Thus, the mixture of baby formula and water from baby formula mixing module 410 may have a temperature no greater than the temperature limit as the mixture exits baby formula mixing module 410. The present subject matter assists with avoiding or preventing dispensing of liquid from baby formula mixing module 410 above the temperature limit.

As a first step, baby formula mixing module 410 is loaded with baby formula. As an example, a user may pour powdered or liquid baby formula into pod 400 and load pod 400 into baby formula mixing module 410. As another example, the user may pour powdered or liquid baby formula directly into baby formula mixing module 410. Pod 400 and/or an interior chamber of baby formula mixing module 410 may be sized for a suitable amount of baby formula. As an example, pod 400 and/or an interior chamber of baby formula mixing module 410 may be sized to receive between two fluid ounces and five fluid ounces of baby formula. Pod 400 may also have a different size and/or shape than pods receivable within another module, such as a coffee brewing module, other than baby formula mixing module 410, e.g., in order to assist with preventing insertion of pod 400 into the other module.

After loading baby formula mixing module 410, the user mounts baby formula mixing module 410 within dispenser recess 168, e.g., such that baby formula mixing module 410 is in fluid communication with water heating assembly 160 via outlet conduit 300. Thus, baby formula mixing module 410 may receive heated water from water heating assembly 160 after baby formula mixing module 410 is mounted within dispenser recess 168.

With baby formula mixing module 410 disposed within dispenser recess 168, controller 170 detects baby formula mixing module 410. In particular, actuator 420 on baby formula mixing module 410 may trigger sensor 330 when baby formula mixing module 410 is mounted within dispenser recess 168, and controller 170 may receive a signal from sensor 330 when baby formula mixing module 410 is mounted at dispenser recess 168.

When baby formula mixing module 410 is mounted within dispenser recess 168 and controller 170 detects baby formula mixing module 410, controller 170 measures a temperature of heated water within water heating assembly 160 prior to flowing any heated water to baby formula mixing module 410. For example, controller 170 may receive a signal from thermistor 314 that corresponds to the temperature of heated water within water heating assembly 160 after detecting baby formula mixing module 410 with sensor 330. Controller 170 opens valve 308 and flows heated water from water heating assembly 160 to baby formula mixing module 410 via outlet conduit 300 when the temperature of water within water heating assembly 160 is no greater than the temperature limit. Conversely, controller 170 does not open valve 308 and heated water from water heating assembly 160 does not flow to baby formula mixing module 410 when the temperature of water within water heating assembly 160 is greater than the temperature limit.

As discussed above, the set temperature of water heating assembly 160 may generally be selected as the default or normal value, e.g., between one hundred and eighty degrees Fahrenheit and one hundred and ninety degrees Fahrenheit. Thus, the normal set temperature for water heating assembly 160 may be significantly (e.g., at least fifty degrees Fahrenheit) greater than the temperature limit for baby formula mixing module 410, and controller 170 may prohibit flowing water to baby formula mixing module 410 until the temperature of water within water heating assembly 160 is no greater than the temperature limit for baby formula mixing module 410.

When the temperature of water within water heating assembly 160 is greater than the temperature limit, controller 170 may empty water from water heating assembly 160. For example, controller 170 may request the user to place a container within dispenser 114, and open one of valves 308 to flow heated water from water heating assembly 160 to heated water outlet 150 and the container therein. As another example, controller 170 can open one of valves 308 to flow heated water from water heating assembly 160 to an evaporation tray (not shown) at a bottom of refrigerator appliance 100, where the water can be evaporated. With the one of valves 308 open, cold water from liquid source 301 may also flow into water heating assembly 160 thereby reducing the temperature of water within water heating assembly 160. In addition, controller 170 may also reduce the set temperature of water heating assembly 160 from the default or normal value to the temperature limit for baby formula mixing module 410 when baby formula mixing module 410 is mounted within dispenser recess 168, e.g., in order to prevent water heating assembly 160 from operating to heat water above the temperature limit for baby formula mixing module 410. Thus, water heating assembly 160 may be drained and refilled when the temperature of water within water heating assembly 160 is greater than the temperature limit in order to reduce the temperature of water within water heating assembly 160.

As discussed above, controller 170 opens valve 308 and flows heated water from water heating assembly 160 to baby formula mixing module 410 via outlet conduit 300 when the temperature of water within water heating assembly 160 is no greater than the temperature limit. Thus, heated water may flow into baby formula mixing module 410 via outlet conduit 300, and the heated water may mix with baby formula within baby formula mixing module 410. The mixture of baby formula and water may then flow out baby formula mixing module 410 into a bottle or other container within dispenser 114. In such a manner, baby formula at a suitable temperature may be dispensed to the container within dispenser 114.

After dispensing the baby formula from baby formula mixing module 410, gas may from the outlet conduit 300 may be flowed into baby formula mixing module 410. By flowing gas after the flow of water and into baby formula mixing module 410, excess liquid may be cleared from pod 400 before removal thereof from baby formula mixing module 410 and/or from baby formula mixing module 410 before removal of baby formula mixing module 410 from dispenser recess 168. After clearing baby formula mixing module 410, the set temperature of water heating assembly 160 may be increased from the temperature limit back to the default or normal set temperature, e.g., between one hundred and eighty degrees Fahrenheit and one hundred and ninety degrees Fahrenheit.

It should be understood that the various steps of the method discussed herein may be performed based on user input and/or performed automatically. For example, all steps may be performed via user input, or automatically, or through a combination of user inputs and automatic steps. In addition, while described above in the context of baby formula, it should be understood that the present subject matter may be used to mix other low temperature beverages, such as protein shakes, sport drinks or flavored water. Thus, any suitable fluid additive may be mixed with water and dispensed at dispenser 114, in alternative exemplary embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for dispensing baby formula at a refrigerator appliance, comprising:
loading a baby formula module with baby formula;
mounting the baby formula module within a dispenser recess of the refrigerator appliance;
detecting the baby formula module with a sensor of the refrigerator appliance;
measuring a temperature of water within a hot water tank of the refrigerator appliance;
flowing water from the hot water tank to the baby formula module when the temperature of water within the hot water tank is no greater than a temperature limit; and
directing a mixture of baby formula and water out of the baby formula module into the dispenser recess.

2. The method of claim 1, wherein the baby formula is powdered baby formula and said step of loading comprises pouring the powdered baby formula into the baby formula module.

3. The method of claim 1, wherein the baby formula is disposed with a pod and said step of loading comprises positioning the pod within the baby formula module.

4. The method of claim 3, wherein the pod is a single-use pod.

5. The method of claim 3, wherein the pod is a refillable pod.

6. The method of claim 1, further comprising emptying the hot water tank before flowing the water from the hot water tank to the baby formula module when the temperature of water within the hot water tank is greater than the temperature limit.

7. The method of claim 6, further comprising refilling the hot water tank and heating water within the hot water tank to a temperature no greater than the temperature limit prior to said step of flowing.

8. The method of claim 1, wherein the temperature limit is not greater than one hundred degrees Fahrenheit.

9. The method of claim 1, wherein water having a temperature greater than the temperature limit is not dispensed while the baby formula module is mounted within the dispenser recess.

10. A refrigerator appliance, comprising:
a cabinet defining a chilled chamber;
a door mounted to the cabinet;
a dispenser mounted to the door, the dispenser defining a recess;
a water heater disposed within the cabinet and having a conduit that extends to the recess;
a baby formula module mounted to the dispenser at the recess of the dispenser such that heated water from the water heater is receivable within the baby formula module, the baby formula module comprising a pod disposed within a body of the baby formula module, the pod filled with baby formula.

11. The refrigerator appliance of claim 10, further comprising a controller configured to:
receive a signal from a sensor positioned adjacent the recess when the baby formula module is mounted to the dispenser at the recess of the dispenser;
measure a temperature of water within a tank of water heater; and
open a valve to flow water from the tank of the water heater to the baby formula module only when the temperature of water within the tank is no greater than a temperature limit.

12. The refrigerator appliance of claim 11, wherein the temperature limit is not greater than one hundred degrees Fahrenheit.

13. The refrigerator appliance of claim 10, wherein the baby formula is powdered baby formula.

14. The refrigerator appliance of claim 10, wherein the baby formula is liquid baby formula.

15. The refrigerator appliance of claim 10, wherein the pod is a single-use pod.

16. The refrigerator appliance of claim 10, wherein the pod is a refillable pod.

17. A method for dispensing a liquid mixture at a refrigerator appliance, comprising:
loading a mixture module with a fluid additive;
mounting the mixture module within a dispenser recess of the refrigerator appliance;
detecting the mixture module with a sensor of the refrigerator appliance;
measuring a temperature of water within a hot water tank of the refrigerator appliance;
flowing water from the hot water tank to the mixture module when the temperature of water within the hot water tank is no greater than a temperature limit; and
directing a mixture of fluid additive and water out of the mixture module into the dispenser recess.
